(19) United States
(12) Patent Application Publication
(10) Pub. No.: US 2025/0300538 A1
(43) Pub. Date: Sep. 25, 2025

(54) Linear Motor

(71) Applicant: AAC Microtech (Changzhou) Co., Ltd., Changzhou City (CN)

(72) Inventors: Zhujiang Xu, Changzhou (CN); Weiwei Tao, Changzhou (CN); Xin Jin, Changzhou (CN); Fan Zhang, Changzhou (CN)

(21) Appl. No.: 18/801,868

(22) Filed: Aug. 13, 2024

Related U.S. Application Data
(63) Continuation of application No. PCT/CN2024/082920, filed on Mar. 21, 2024.

(51) Int. Cl. H02K 33/18; H02K 5/24; H02K 33/02

(52) U.S. Cl. CPC H02K 33/18; H02K 5/24; H02K 33/02

(57) ABSTRACT

The invention provides a linear motor which includes a housing with a hosing chamber, a vibrating unit, a driving unit and elastic pieces, wherein the vibrating unit, the driving unit and the elastic pieces are arranged in the housing chamber. The linear motor includes a foam damping having local melting points. According to the linear motor, the foam damping is heated at fixed points, the bonding between the foam damping and the elastic piece is realized by means of the self viscosity of the foam damping after the foam damping is melted. The foam glue in the related technology is replaced, the Z-direction space is saved. Glue overflows to other parts on two sides to influence the assembly procedure of the linear motor can be effectively prevented, and therefore the vibration performance of the linear motor is improved.

### TECHNICAL FIELD

The present invention relates to the field of electromechanical devices, in particular to a linear motor.

### BACKGROUND

With the advent of the mobile internet age, the number of intelligent mobile devices has increased. Among the mobile devices, the mobile phone is certainly the most common and portable intelligent mobile device, and the vibration function becomes the basic function in the intelligent mobile device, so the linear motor with the vibration function is widely applied to the intelligent mobile device.

The linear motor of the related art comprises a housing, a vibrating unit accommodated in the housing, an elastic member suspending the vibrating unit in the housing and a driving unit driving the vibrating unit to vibrate, wherein the vibrating unit comprises a mass and a rotor fixed on the mass, when the linear motor vibrates, proper damping is provided between the mass and the elastic member in a foam-filling mode, and the edge of the joint of the foam and the elastic member and/or the mass is glued and fixed, so that foam is prevented from falling in the vibration process.

However, the foam gel state in the related art is influenced by the assembly level, and the condition of ultrahigh glue is easy to occur, so that Z-direction space interference is caused, and the vibration performance of the linear motor is influenced.

Accordingly, there is a need to provide a new linear motor that solves the above-mentioned technical problems.

### SUMMARY

The invention aims to provide a linear motor which saves Z-directional space and has good vibration performance.

To achieve the above-mentioned objective, the present invention provides a linear motor comprising: a housing with a housing chamber including an upper cover and a lower cover; a vibrating unit arranged in the housing chamber, and including a mass and a rotor fixed on the mass; a driving unit driving the vibrating unit to vibrate; an elastic member suspending the vibrating unit in the housing chamber; and a foam damping connected between the mass and the elastic member. The driving unit is one of a coil and a magnet assembly, the rotor is the other of the coil and the magnet assembly, and the foam damping comprises local melting points that are melted through heating, so that the foam damping is adhered to the mass and/or the elastic member.

As an improvement, the local melting point is heated by laser thermal energy.

As an improvement, the elastic member includes two elastic arms located at both sides of a vibration direction of the vibration unit, each of the clastic arms including a first fixing portion fixed to the housing, a second fixing portion fixed to a side surface of the mass, and a connection arm connecting the first fixing portion and the second fixing portion; the foam damping is fixed to the connection arm; the elastic member further comprises a cantilever connected with the two second fixing parts, and the cantilever is fixedly attached to the bottom surface of the mass and is arranged at intervals with the lower cover.

As an improvement, the mass includes a planar portion provided in parallel with the lower cover at a spacing and having a hollow positioning groove, and an adhesive portion formed to protrude from an outer side end of the planar portion in a direction away from the lower cover; the rotor is accommodated in the positioning groove; the foam is fixed on the bonding part in a damping way.

As an improvement, the linear motor includes two weight blocks perpendicular to both sides of the vibration direction and fixed on a top surface of the mass; wherein a bottom surface of the mass is fixedly provided with a supporting sheet surrounded by the cantilever, the rotor is the coil, and the coil is fixed on the supporting sheet.

As an improvement, the rotor further includes a circuit board electrically connected to the coil; the circuit board includes a first portion fixed to a bottom surface of the mass, a second portion extending from the first portion and fixed to a side surface of the mass, a third portion located outside the housing and connected to an external circuit, and a deformation portion connecting the second portion and the third portion; the deformation portion is deformable in the vibration direction; the cantilever comprises a notch part, the first part penetrates through the notch part and is arranged at intervals with the cantilever, and a coil lead wire of the coil is electrically connected with the first part.

As an improvement, the support piece includes a hollow groove, and a protrusion protruding toward and supporting the driving unit is provided at a center of the lower cover, the protrusion penetrating the groove and the positioning groove; the driving unit is the magnet assembly, and the magnet assembly is fixed on the protruding part and is arranged at intervals with the rotor.

As an improvement, one side of the upper cover is provided with a sound outlet; the linear motor further comprises a frame fixed to the housing, a vibration system fixed to the frame, and a magnetic circuit system driving the vibration system to vibrate; the magnetic circuit system comprises a lower plate fixed to the lower cover, a main magnetic assembly disposed on the lower plate, and an auxiliary magnetic assembly disposed around the main magnetic assembly for forming a magnetic gap; the magnetic circuit system is used as the magnet assembly; the coil comprises a hollow winding hole, and the winding hole is opposite to the magnetic gap.

As an improvement, the main magnetic assembly comprises a first main magnet disposed on the lower plate, a main pole core disposed on the first main magnet, and a second main magnet disposed on the main pole core; the auxiliary magnetic assembly comprises an auxiliary pole core fixed on the frame and a plurality of auxiliary magnets attached to the auxiliary pole core, and the auxiliary magnets are spaced from the coil.

As an improvement, the vibration system comprises a diaphragm fixed to the frame, a voice coil inserted in the magnetic gap and driving the diaphragm to vibrate, a bobbin connecting the diaphragm, and a flexible member fixed to the frame and disposed at a distance from the diaphragm and the mass; the bobbin comprises a main body part attached to the vibrating diaphragm, a first supporting arm extending along the outer periphery of the main body part in a direction away from the vibrating diaphragm, and a second supporting arm extending along the inner periphery of the main body part in a direction away from the vibrating diaphragm; the flexible member is connected between the first supporting arm and the frame; the voice coil is fixed on the second supporting arm; the inner side end of the flexible member extends to the main body part to form a lead connecting part, the lead connecting part is fixed on one side, far away from the vibrating diaphragm, of the main body part, and a voice coil lead of the voice coil is connected with the lead connecting part.

Compared with the related art, the linear motor provided by the invention has the advantages that the local melting point is arranged on the foam damping, the local melting point is heated at fixed point through laser heat energy The foam damping and the mass block and/or the foam damping and the elastic piece are bonded by means of the viscosity of the foam damping after melting. The foam damping and the mass block and/or the foam damping and the elastic piece are replaced by the foam damping, the Z-direction space is saved, and the glue can be effectively prevented from overflowing to other parts on two sides to influence the assembly procedure of the linear motor, so that the vibration performance of the linear motor is improved.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view showing a linear motor in accordance with a first embodiment of the present invention, removing a driving unit and an upper cover;

FIG. 2 illustrates an assembly of a mass, a coil, a supporting plate, a circuit board and an elastic member of the linear motor of the first embodiment;

FIG. 3 is an exploded view of the linear motor of the first embodiment;

FIG. 4 is an exploded view of a linear motor in accordance with a second embodiment of the present invention;

FIG. 5 is an isometric view of the linear motor of the second embodiment;

FIG. 6 is a cross-sectional view of the linear motor of the second embodiment, taken along line A-A in FIG. 5.

### DETAILED DESCRIPTION OF THE EMBODIMENTS

The following will be taken in conjunction with the accompanying drawings of embodiments of the present invention, The technical scheme in the embodiment of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

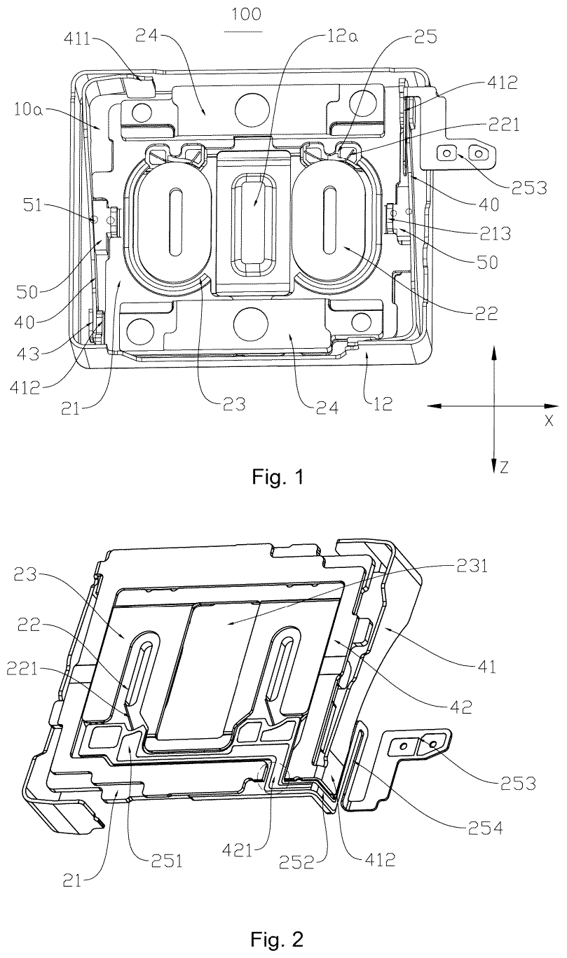

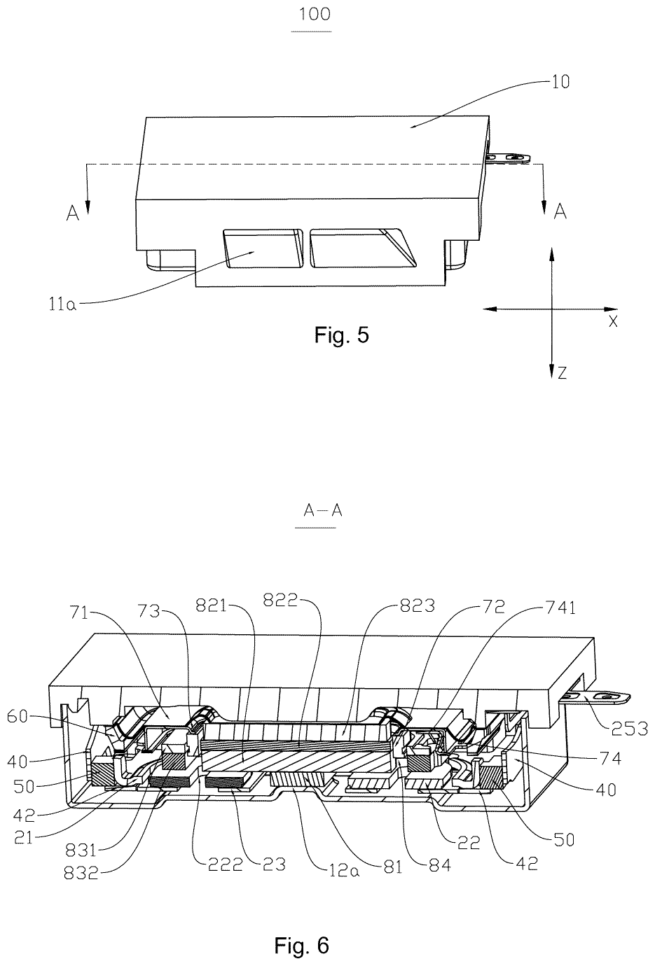

Referring to FIGS. 1-6, the present invention provides a linear motor 100, which includes a housing 10 having a housing chamber 10a, a vibration unit disposed in the housing chamber 10a, a driving unit for driving the vibration unit to vibrate, and elastic members 40 disposed on both sides of the vibration unit in a vibration direction X.

The housing 10 comprises an upper cover 11 and a lower cover 12, the vibration unit comprises a mass 21 and a rotor fixed on the mass 21, the driving unit is one of a coil 22 and a magnet assembly 31, and the rotor is the other of the coil 22 and the magnet assembly 31; when the driving unit is a coil 22, the rotor is a magnet assembly 31; when the driving unit is the magnet assembly 31, the rotor is the coil 22, and the specific setting mode is determined as described in actual requirements.

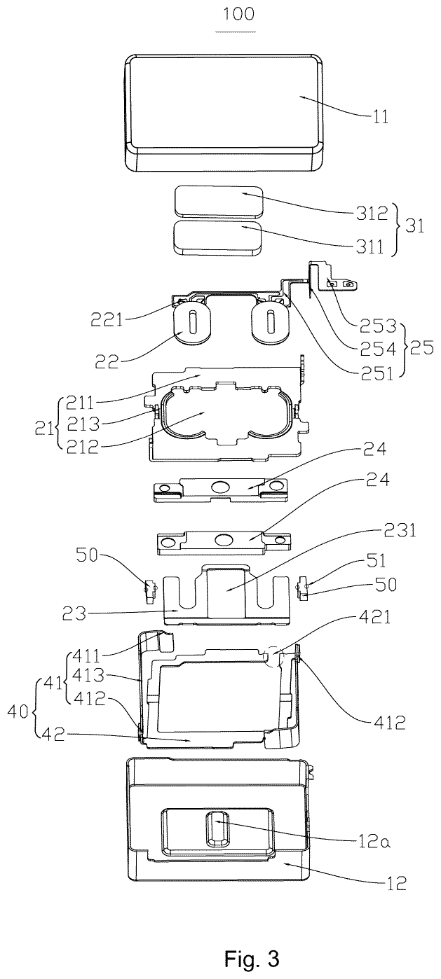

Referring to FIG. 3, the elastic member 40 includes two elastic arms 41 located at both sides of the vibration direction X of the vibration unit, each elastic arm 41 includes a first fixing portion 411 fixed to the housing 10, a second fixing portion 412 fixed to a side surface of the mass 21, and a connecting arm 413 connecting the first fixing portion 411 and the second fixing portion 412, and the surfaces of the first fixing portion 411 and the second fixing portion 412, which are far from the housing 10 and the mass 21, respectively, are fixed with a soldering lug 43; the elastic member 40 further includes a cantilever 42 connected to the two second fixing portions 412, and the cantilever 42 is attached to the bottom surface of the mass 21 and spaced from the lower cover 12. The cantilever 42 is connected with the two elastic arms 41 to form an integrated elastic member 40 structure, which can improve the consistency of the two elastic arms 41 and the symmetry of the vibration unit in the linear motor 100, reduce the swinging degree of the linear motor 100, and enable the linear motor 100 to have better vibration performance.

The mass 21 comprises a plane part 211 which is arranged in parallel with the lower cover 12 at intervals and provided with a hollow positioning groove 212, and an adhesion part 213 which is formed by protruding from the outer side end of the plane part 211 to the direction away from the lower cover 12; the rotor is accommodated and fixed in the positioning groove 212, so that the rotor is more stably fixed with the mass 21, and meanwhile, the height space occupied by the rotor is reduced.

Further, a foam damper 50 is connected between the mass 21 and the elastic member 40, the foam damper 50 is sandwiched between the connecting arm 413 and the bonding portion 213. The foam damper 50 includes a local melting point 51 located between the foam damper 50 and the connecting arm 413 and between the foam damper 50 and the bonding portion 213. The foam damper 50 can be made to have viscosity by heating and melting at the local melting point 51, so that the foam damper 50 is fixedly connected with the mass 21 and/or the elastic member 40.

Preferably, the local melting point 51 of the foam damper 50 can be heated by means of laser heat energy, so that the foam damper 50 is fixed with the elastic element 40 and/or the mass 21.

Compared with the related art, the linear motor 100 of the invention realizes the adhesion of the foam damping 50 and the mass 21 and/or the elastic member 40 by arranging the local melting point 51 on the foam damping 50 and heating to melt the local melting point 51 and depending on the viscosity of the foam damping 50 after melting, replaces the foam glue in the prior art, saves the Z-direction space, and can also effectively prevent glue from overflowing to other parts on two sides so as to influence the assembly procedure of the linear motor 100, thus leading the vibration performance of the linear motor 100 to be better.

Specifically, referring to FIG. 1, two weight blocks 24 perpendicular to two sides of the vibration direction X are fixed on the top surface of the mass 21, and the two weight blocks 24 are symmetrically arranged, so that the mass of the mass 21 can be increased, and the problems of light weight and unstable vibration of the mass 21 caused by the arrangement of the hollow positioning groove 212 can be solved.

A support plate 23 surrounded by the cantilever 42 is fixed on the bottom surface of the mass 21, and the support plate 23 includes a hollow recess 231. The lower cover 12 is provided at the center thereof with a protrusion 12a protruding toward and supporting the driving unit. The protrusion 12a penetrates the groove 231 and the positioning groove 212.

In order to better embody the specific structure of the linear motor 100 of the present invention, the following will be explained by two specific embodiments:

### First Embodiment

Referring to FIGS. 1 to 3, in the present embodiment, the driving unit is a magnet assembly 31, the rotor includes a coil 22, and the magnet assembly 31 is fixed to the protrusion 12a and is spaced from the coil 22. The coil 22 is accommodated in the positioning groove 212 of the mass 21 and is fixed to the support piece 23, thereby fixing the coil 22 to the mass 21.

In addition, referring to FIG. 2, the rotor further includes a circuit board 25 electrically connected to the coil 22, the circuit board 25 including a first portion 251 fixed to the bottom surface of the mass 21, a second portion 252 extending from the first portion 251 and fixed to the side surface of the mass 21, a third portion 253 located outside the case 10 and connected to an external circuit, and a deformation portion 254 connecting the second portion 252 and the third portion 253 and capable of deforming in the vibration direction X. The cantilever 42 includes a notch 421 through which the first portion 251 passes and is spaced apart from the cantilever 42. The first portion 251 is connected to the coil lead 221 of the coil 22 to introduce an electrical signal to the coil 22, thereby enabling independent control of the linear motor 100.

In the present embodiment, the magnet assembly 31 includes a magnet 311 fixed to the protrusion 12a and a pole piece 312 disposed on the magnet 311. The number of coils 22 is two, and the coils are respectively positioned at two sides of the vibration direction X and symmetrically arranged at two sides of the protrusion 12a.

The principle of vibration of the linear motor 100 in the present embodiment is: the coil 22 is in the magnetic field range of the magnet assembly 31 and interacts to generate an electromagnetic field; at this time, the mutual driving force with the magnet assembly 31 can be realized by controlling the current direction of the coil 22. The coil 22 is fixed on the mass 21, and is suspended in the housing chamber 10a together with the mass 21 through the elastic member 40 to serve as a vibration unit; the magnet assembly 31 is disposed at a distance from the coil 22, and is fixed on the protrusion 12a of the lower cover 12, and is used as a fixed driving unit, so that the coil 22 and the mass 21 vibrate simultaneously under the driving of the magnetic field, thereby driving the whole linear motor 100 to vibrate.

### Second Embodiment

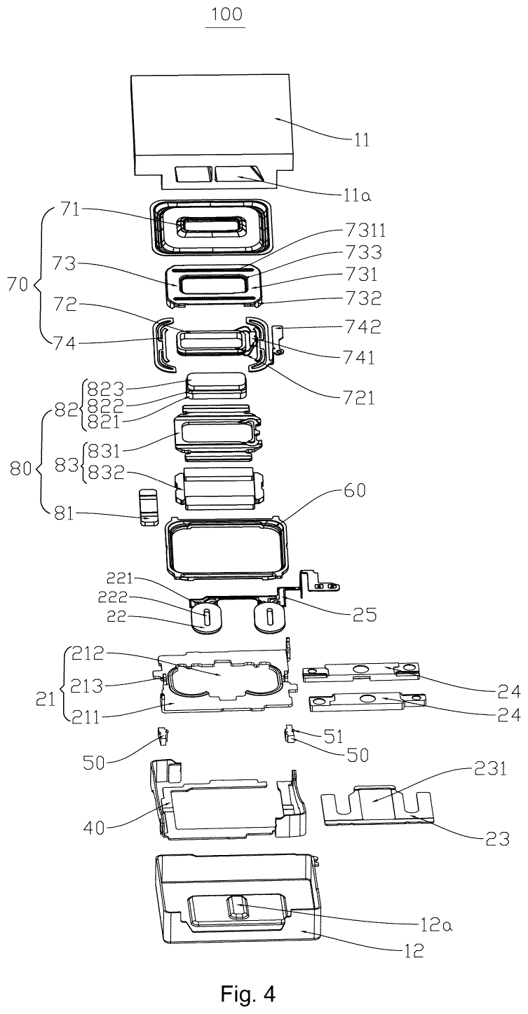

Referring to FIGS. 4 to 6, the linear motor 100 of the present embodiment further includes a frame 60 fixed to the housing 10, a vibration system 70 fixed to the frame 60, and a magnetic circuit system 80 driving the vibration system 70 to vibrate. The magnetic circuit 80 includes a lower plate 81 fixed to the lower cover 12, a main magnetic assembly 82 disposed on the lower plate 81, and an auxiliary magnetic assembly 83 disposed around the main magnetic assembly 82 to form a magnetic gap 84.

In this embodiment, the driving unit is a magnet assembly 31, and the magnetic circuit system 80 is the magnet assembly 31. The rotor is a coil 22 fixed on the mass 21, the coil 22 comprises a hollow winding hole 222, and the winding hole 222 is opposite to the magnetic gap 84.

In addition, the rotor further includes a circuit board 25 electrically connected to the coil 22, and the circuit board 25 is connected to a coil lead 221 of the coil 22 to introduce an electric signal to the coil 22, thereby achieving independent control of the linear motor 100.

Furthermore, the upper cover 11 of the present embodiment is further provided with a sound outlet 11a, and the vibration system 70, the magnetic circuit system 80 and the frame 60 together form a sound generating unit for generating sound, and sound is output to the outside through the sound outlet 11a, so that the linear motor 100 of the present embodiment further has a sound generating function in addition to the vibration function.

Specifically, the main magnetic assembly 82 includes a first main magnet 821 disposed on the lower clamping plate 81, a main pole core 822 disposed on the first main magnet 821, and a second main magnet 823 disposed on the main pole core 822, the auxiliary magnetic assembly 83 includes an auxiliary pole core 831 fixed on the frame 60 and four auxiliary magnets 832 attached to the auxiliary pole core 831, the four auxiliary magnets 832 are disposed at intervals with the coil 22, and the four auxiliary magnets 832 are symmetrical with respect to the main magnetic assembly 82 in any direction, so that the compactness and stability of the magnetic circuit system 80 can be enhanced.

In this embodiment, the vibration system 70 includes a diaphragm 71 fixed to the frame 60, a voice coil 72 inserted in the magnetic gap 84 and driving the diaphragm 71 to vibrate, a bobbin 73 connected to the diaphragm 71, and a flexible member 74 fixed to the frame 60 and spaced apart from the diaphragm 71 and the mass 21;
the bobbin 73 includes a main body 731 attached to the diaphragm 71, a first support arm 732 extending along an outer periphery of the main body 731 in a direction away from the diaphragm 71, and a second support arm 733 extending along an inner periphery of the main body 731 in a direction away from the diaphragm 71, the flexible member 74 is connected between the first support arm 732 and the frame 60, and the voice coil 72 is suspended in the magnetic gap 84 by the second support arm 733.

Further, two glue grooves 7311 are symmetrically distributed on the main body 731 of the bobbin 73, the two glue grooves 7311 are located at two sides perpendicular to the vibration direction X, and of course, the two glue grooves 7311 may be located at two sides of the vibration direction X as described in practical situations, and glue may be filled in the two glue grooves 7311 to fix the bobbin 73 and the diaphragm 71.

The number of the flexible members 74 is two, the two flexible members 74 are respectively located at both sides of the vibration direction X, the inner side end of one flexible member 74 extends out of the lead connection portion 741 toward the main body portion 731, the lead connection portion 741 is fixed to the side of the main body portion 731 away from the diaphragm 71, and the voice coil lead 721 of the voice coil 72 is connected to the lead connection portion 741. The outer end of the flexible member 74 extends outwardly to form an electrical connection 742 for electrical connection to an external circuit.

The vibration principle of the linear motor 100 of the present embodiment is: the coil 22 is located in the magnetic field range of the magnetic circuit system 80 and interacts to generate an electromagnetic field, meanwhile, the mutual driving force with the magnetic circuit system 80 can be realized by controlling the current direction of the coil 22; the magnetic circuit system 80 is fixed to the housing 10 through the frame 60, and as a driving unit, the coil 22 and the mass 21 are elastically suspended in the housing chamber 10a through the elastic member 40, and as a vibration unit, the magnetic circuit system 80 can make the coil 22 and the mass 21 vibrate at the same time, so as to drive the whole linear motor 100 to vibrate.

The foregoing is merely illustrative of embodiments of the present invention, and it should be noted that modifications may be made to those skilled in the art without departing from the spirit of the invention but are intended to be within the scope of the invention.

What is claimed is:

1. A linear motor comprising:
a housing with a housing chamber, including an upper cover and a lower cover;
a vibrating unit arranged in the housing chamber, and including a mass and a rotor fixed on the mass;
a driving unit driving the vibrating unit to vibrate;
an elastic member suspending the vibrating unit in the housing chamber;
a foam damping connected between the mass and the elastic member;
wherein the driving unit is one of a coil and a magnet assembly, the rotor is the other of the coil and the magnet assembly, and the foam damping comprises local melting points that are melted through heating, so that the foam damping is adhered to the mass and/or the elastic member.

2. The linear motor as described in claim 1, wherein the local melting point is heated by laser thermal energy.

3. The linear motor as described in claim 1, wherein the elastic member includes two elastic arms located at both sides of a vibration direction of the vibration unit, each of the elastic arms including a first fixing portion fixed to the housing, a second fixing portion fixed to a side surface of the mass, and a connection arm connecting the first fixing portion and the second fixing portion; the foam damping is fixed to the connection arm; the elastic member further comprises a cantilever connected with the two second fixing parts, and the cantilever is fixedly attached to the bottom surface of the mass and is arranged at intervals with the lower cover.

4. The linear motor as described in claim 3, wherein the mass includes a planar portion provided in parallel with the lower cover at a spacing and having a hollow positioning groove, and an adhesive portion formed to protrude from an outer side end of the planar portion in a direction away from the lower cover; the rotor is accommodated in the positioning groove; the foam is fixed on the bonding part in a damping way.

5. The linear motor as described in claim 4 comprising two weight blocks perpendicular to both sides of the vibration direction and fixed on a top surface of the mass, wherein a bottom surface of the mass is fixedly provided with a supporting sheet surrounded by the cantilever, the rotor is the coil, and the coil is fixed on the supporting sheet.

6. The linear motor as described in claim 5, wherein the rotor further includes a circuit board electrically connected to the coil; the circuit board includes a first portion fixed to a bottom surface of the mass, a second portion extending from the first portion and fixed to a side surface of the mass, a third portion located outside the housing and connected to an external circuit, and a deformation portion connecting the second portion and the third portion; the deformation portion is deformable in the vibration direction; the cantilever comprises a notch part, the first part penetrates through the notch part and is arranged at intervals with the cantilever, and a coil lead wire of the coil is electrically connected with the first part.

7. The linear motor as described in claim 5, wherein the support piece includes a hollow groove, and a protrusion protruding toward and supporting the driving unit is provided at a center of the lower cover, the protrusion penetrating the groove and the positioning groove; the driving unit is the magnet assembly, and the magnet assembly is fixed on the protruding part and is arranged at intervals with the rotor.

8. The linear motor as described in claim 1, wherein one side of the upper cover is provided with a sound outlet; the linear motor further comprises a frame fixed to the housing, a vibration system fixed to the frame, and a magnetic circuit system driving the vibration system to vibrate; the magnetic circuit system comprises a lower plate fixed to the lower cover, a main magnetic assembly disposed on the lower plate, and an auxiliary magnetic assembly disposed around the main magnetic assembly for forming a magnetic gap; the magnetic circuit system is used as the magnet assembly; the coil comprises a hollow winding hole, and the winding hole is opposite to the magnetic gap.

9. The linear motor as described in claim 8, wherein the main magnetic assembly comprises a first main magnet disposed on the lower plate, a main pole core disposed on the first main magnet, and a second main magnet disposed on the main pole core; the auxiliary magnetic assembly comprises an auxiliary pole core fixed on the frame and a plurality of auxiliary magnets attached to the auxiliary pole core, and the auxiliary magnets are spaced from the coil.

10. The linear motor s described in claim 8, wherein the vibration system comprises a diaphragm fixed to the frame, a voice coil inserted in the magnetic gap and driving the diaphragm to vibrate, a bobbin connecting the diaphragm, and a flexible member fixed to the frame and disposed at a distance from the diaphragm and the mass; the bobbin comprises a main body part attached to the vibrating diaphragm, a first supporting arm extending along the outer periphery of the main body part in a direction away from the vibrating diaphragm, and a second supporting arm extending along the inner periphery of the main body part in a direction away from the vibrating diaphragm; the flexible member is connected between the first supporting arm and the frame; the voice coil is fixed on the second supporting arm; the inner side end of the flexible member extends to the main body part to form a lead connecting part, the lead connecting part is fixed on one side, far away from the vibrating diaphragm, of the main body part, and a voice coil lead of the voice coil is connected with the lead connecting part.
